(19) United States
(12) Patent Application Publication
(10) Pub. No.: US 2010/0264210 A1
(43) Pub. Date: Oct. 21, 2010

(54) IC card with display function

(76) Inventor: De-Yu Kao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/764,936

(22) Filed: Apr. 21, 2010

(30) Foreign Application Priority Data
Apr. 21, 2009 (TW) 098113170

(51) Int. Cl. G06K 5/00

(52) U.S. Cl. 235/380

(57) ABSTRACT

IC card with display function includes a CPU, a card interface, a non-volatile memory, a volatile memory, and a display device. The CPU communicates with an external card reader through the card interface for accessing the data stored in the non-volatile memory. The non-volatile memory stores an encryption key and encrypted data. The volatile memory stores decrypted data temporarily for providing the CPU to transmit the stored data of the volatile memory to the display device for display.

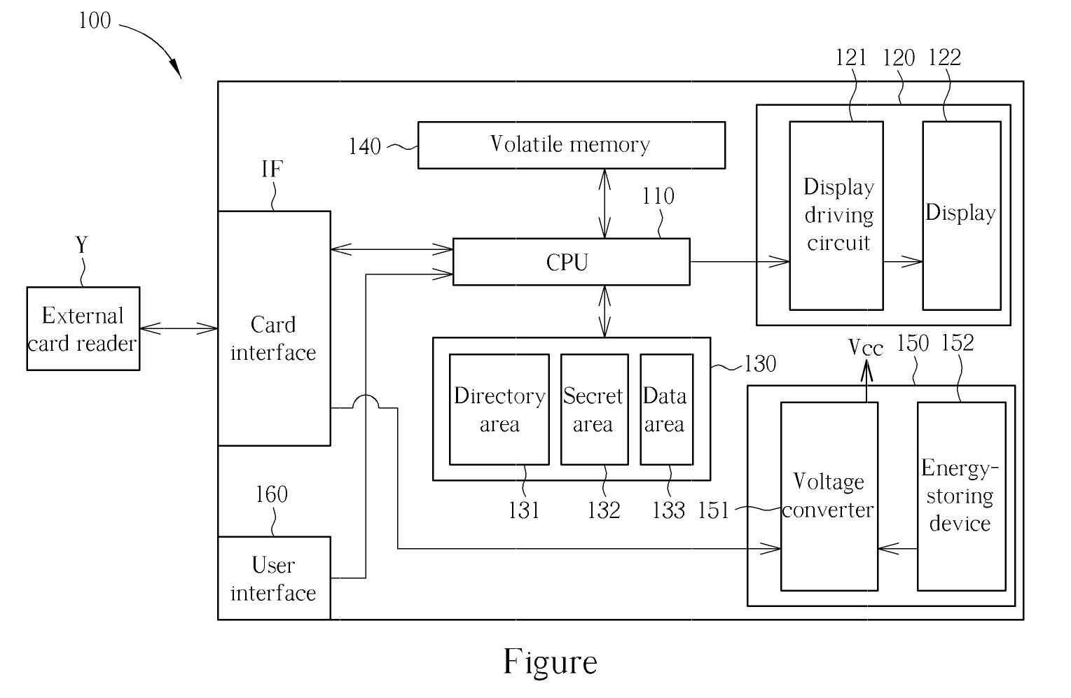

### BACKGROUND OF THE INVENTION

1. Field of the Invention

The present invention relates to an Integrated Chip (IC) card, and more particularly, to an IC card with display function.

2. Description of the Prior Art

The magnetic strip card is utilized for transactions in the prior art. However, since the data stored in the magnetic strip of the magnetic strip card can be easily accessed and the stored data can not be encrypted, the magnetic strip card is easy to be duplicated.

Hence, in the prior art, the technology of IC card is proposed for replacing the magnetic strip card in transactions. The IC card has the advantage that the stored data can be encrypted so that the IC card is difficult to be duplicated, providing more security for transaction. Thus, the IC card is utilized in various transactions, for example, the credit card, the bank card, the pre-paid card for transportation and so on.

However, when the data stored in the IC card is to be accessed, a card reader corresponding to the IC card is required for accessing the stored data. For example, when the user wonders to know the balance in the pre-paid card, the user can not directly access the information of remaining sum saved in the IC card. Instead, the user has to utilize the card reader disposed in the station for accessing the stored data (the balance), causing a great inconvenience.

### SUMMARY OF THE INVENTION

The present invention provides an Integrated Chip (IC) card with display function. The IC card comprises a Central Processing Unit (CPU), a volatile memory, a non-volatile memory, a card interface, and a display device. The Central Processing Unit is for executing an IC card process according to a control signal. The volatile memory is coupled to the Central Processing Unit for storing a data signal. The non-volatile memory is coupled to the Central Processing Unit for storing the control signal. The card interface is coupled to the Central Processing Unit for communication between the Central Processing Unit and an external card reader. The display device is controlled by the Central Processing Unit for display. The Central Processing Unit controls the display device according to the data signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The FIGURE is a diagram illustrating an Integrated Chip card with display function according to an embodiment of the present invention.

### DETAILED DESCRIPTION

The present invention provides an Integrated Chip (IC) card with display function. The IC card of the present invention can display data stored in the IC card, providing a great convenience.

Please refer to the FIGURE, which is a diagram illustrating an IC card 100 with display function according to an embodiment of the present invention. As shown in the FIGURE, the IC card 100 comprises a Central Processing Unit (CPU) 110, a display device 120, a non-volatile memory 130, a volatile memory 140, a power circuit 150, a user interface 160, and a card interface IF.

The non-volatile memory 130 is coupled to the CPU 110. The non-volatile memory 130 has a directory area 131, a secret area 132, and a data area 133. The directory area 131 records the address and the length of the stored data. The secret area 132 is utilized for storing the encryption key X. The data area 133 is utilized for storing the encrypted data (for example, the encrypted data for the balance). In other words, the data stored in the directory area 131 and the secret area 132 are utilized as a control signal stored in the non-volatile memory 130 for the CPU 110 to execute an IC card process according to the control signal.

The volatile memory 140 is coupled to the CPU 110, and is mainly utilized for temporarily storing the decrypted data (for example, the decrypted data for the balance) so as to provide the CPU 110 to transmit the stored data from the volatile memory 140 to the display device 120 for display. In this way, the display device 120 can show the received data. In other words, the volatile memory 140 stores the data signal so as to provide the CPU 110 to access the data signal and control the display device 120 accordingly.

The CPU 110 is loaded with a Card Operating System (COS) for executing the IC card process of the IC card 100, e.g. the card authorization, the terminal authorization or the user authorization, etc. The CPU 110 is coupled to the card interface IF for communication between the CPU 110 and an external card reader Y through the card interface IF. The CPU 110 encrypts the received data (from the external card reader Y) according to the encryption key X stored in the secret area 132 of the non-volatile memory 130. Then, the encrypted data is stored in the data area 133 of the non-volatile memory 130. When the external card reader Y is to access the stored data of the data area 133 of the non-volatile memory 130, the CPU 110 decrypts the stored data of the data area 133 of the non-volatile memory 130 according to the encryption key X, and then transmits the decrypted data to the external card reader Y through the card interface IF; when the external card reader Y is to modify the stored data of the data area 133 of the non-volatile memory 130, the CPU 110 encrypts the instruction and the data transmitted of the external card reader Y according to the encryption key X, and then writes the encrypted data into the data area 133 of the non-volatile memory 130.

The user interface 160, for example, can be a button for providing the user to communicate with the CPU 110. When the user is to directly access the stored data of the data area 133 of the non-volatile memory 130, the user can notify the CPU 110 through the user interface 160. For example, the user can push the button so as to send the user signal, representing that the user is to access the stored data, to the CPU 110. When the CPU 110 receives the user signal representing that the user is to access the stored data, the CPU 110 decrypts the stored data of the data area 133 according to the encryption key X. Then, the CPU 110 stores the decrypted data in the volatile memory 140 and transmits the decrypted data stored in the volatile memory 140 to the display device 120 for display. In this way, the user can control the CPU 110 through the user interface 160 so as to read the data through the display device 120. The user interface 160 may generate the user signal to the CPU 110 to control the display device 120. For example, the user can push the button of the IC card 100 so that the display device 120 of the IC card 100 displays the data for the balance of the IC card 100. In this way, the user can access the data for the balance of the IC card 100 without an external card reader.

The power circuit 150 is utilized for providing power through the power source V_{CC} to each component of the IC card 100 for operation. The power circuit 150 comprises a voltage converter 151. In addition, the power circuit 150 also can selectively comprise an energy-storing device 152. The voltage converter 151 is utilized for converting the received electrical energy into the power source V_{CC}; the energy-storing device 152 can store the electrical energy. The energy-storing device 152 can be a solar battery or a general rechargeable battery. When the energy-storing device 152 is a solar battery, if the IC card 100 receives the solar energy, the energy-storing device 152 can store the electrical energy and providing the power circuit 150 to generate the power source V_{CC}. When the energy-storing device 152 is a rechargeable battery, if the IC card 100 communicates with the external card reader through the card interface IF, the IC card 100 can receive the electrical energy from the external card reader and store the electrical energy in the energy-storing device 152 for providing the power circuit 150 to generate the power source V_{CC}.

Furthermore, the card interface IF may include a contact card interface, a contact-less card interface, or a hybrid card interface. The hybrid card interface comprises a contact card interface, and a contact-less card interface. When the card interface IF is a contact-less card interface, the power circuit 150 can receives the electrical energy from the received radio frequency signal through the contact-less card interface, and converts the electrical energy into the power source V_{CC}; when the card interface is a contact card interface, the power circuit 150 can receive the electrical energy transmitted from the contact card interface, and converts the electrical energy into the power source V_{CC}. The display device 120 comprises a display driving circuit 121, and a display 122. The display driving circuit 121 is utilized for driving the display 122 according to the signal transmitted from the CPU 110 (for example, the display driving circuit 121 may include a boost circuit for raising up the voltage level of the signal transmitted from the CPU 110 for driving the display 122). The display 122 may include a bi-stable display. That is, when the display 122 displays data, the display 122 can keep displaying the displayed data without consuming power, until the displayed data is updated next time.

The IC card 100 of the present invention has another advantage, which is: providing the volatile memory 140 so as to reduce the required capacity of the non-volatile memory 130. For example, if the IC card 100 of the present invention does not have the volatile memory 140, an additional data area is required in the non-volatile memory 130 for storing the decrypted data (for separating from the encrypted data). Therefore, the capacity of the non-volatile memory 130 has to be enlarged. However, since the capacity and the cost of the non-volatile memory are smaller and higher than the volatile memory, the capacity of the non-volatile memory 130 of the IC card 100 can be effectively reduced because of the volatile memory 130, reducing the cost of the IC card 100.

In conclusion, by means of the IC card with display function of the present invention, the user can directly read the stored data from the IC card. In addition the IC card of the present invention has the volatile memory for temporarily storing data. Thus, the capacity of the non-volatile memory can be effectively reduced which reduces the overall cost, causing a great convenience.

Those skilled in the art will readily observe that numerous modifications and alterations of the device and method may be made while retaining the teachings of the invention.

What is claimed is:

1. An Integrated Chip (IC) card with display function, comprising:
a Central Processing Unit (CPU) for executing an IC card process according to a control signal;
a volatile memory coupled to the Central Processing Unit for storing a data signal;
a non-volatile memory coupled to the Central Processing Unit for storing the control signal;
a card interface coupled to the Central Processing Unit for communication between the Central Processing Unit and an external card reader; and
a display device controlled by the Central Processing Unit for display;
wherein the Central Processing Unit controls the display device according to the data signal.

2. The IC card of claim 1, wherein the nonvolatile memory comprises:
a directory area for recording address and length of data;
a secret area for storing an encryption key; and
a data area for storing encrypted data;
wherein data stored in the directory area and the secret area are utilized as the control signal;
wherein the CPU encrypts a first data according to the encryption key and stores the encrypted first data in the data area of the non-volatile memory.

3. The IC card of claim 2, wherein the volatile memory is utilized for storing decrypted data as the data signal;
wherein the CPU decrypts a second data of the data area of the non-volatile memory according to the encryption key so as to transmit the decrypted second data to the volatile memory as the data signal.

4. The IC card of claim 2, wherein when the external card reader accesses data stored in the non-volatile memory, the CPU decrypts the data according to the encryption key, and transmits the decrypted data to the external card reader through the card interface.

5. The IC card of claim 2, wherein the external card reader modifies the data stored in the non-volatile memory, the CPU encrypts data and instruction of the external card reader according to the encryption key, and writes the encrypted data into the data area of the non-volatile memory.

6. The IC card of claim 1, wherein the display device comprises:
a display; and
a display driving circuit for driving the display according to signal transmitted from the CPU.

7. The IC card of claim 1, wherein the display includes a bi-stable display device, and the display driving circuit includes a boost circuit.

8. The IC card of claim 2, further comprising:
a user interface for generating a user signal to the CPU to control the display device.

9. The IC card of claim 1, wherein the card interface includes a contact card interface, a contact-less card interface, or a hybrid card interface.

10. The IC card of claim 9, further comprising a power circuit for providing power to components of the IC card.

11. The IC card of claim 10, wherein the power circuit comprises:
a voltage converter for receiving electrical energy and converting electrical energy into the power source.

12. The IC card of claim 11, wherein when the external card reader communicates with the IC card, the voltage converter receives electrical energy and converts electrical energy into the power source through the card interface.

13. The IC card of the claim 1, further comprising:
a power circuit for providing a power source to components of the IC card, wherein the power circuit has an energy-storing device for storing electrical energy; and a voltage converter for converting electrical energy stored in the energy-storing device into the power source.

14. The IC card of claim 13, wherein the energy-storing device includes a solar battery or a rechargeable battery.
